(19) United States
(12) Patent Application Publication
(10) Pub. No.: US 2018/0056457 A1
(43) Pub. Date: Mar. 1, 2018

(54) Part Holder Utilizing Interlocking Pin and Plate Design

(71) Applicant: Production Solutions, Inc., Poway, CA (US)

(72) Inventor: Douglas T Farlow, Poway, CA (US)

(73) Assignee: Production Solutions, Inc.

(21) Appl. No.: 15/688,311

(22) Filed: Aug. 28, 2017

Related U.S. Application Data
(60) Provisional application No. 62/380,840, filed on Aug. 29, 2016.

(51) Int. Cl. B23K 37/04; B25B 5/06

(52) U.S. Cl. CPC B23K 37/04; B25B 5/06

(57) ABSTRACT

A fixture includes at least one first plate having a plurality of holes formed therethrough. At least one second plate has a plurality of holes formed therethrough in alignment with the holes in the first plate. At least some of the holes in the second plate have at least one indentation formed therein in a radial direction. The second plate is aligned parallel to the first plate and is moveable along an axis from an open position where the holes in the plates are axially aligned to a locked position where the first and second holes are offset. A plurality of pins have diameters less than the and holes. Each pin has at least one region extending outwardly in a radial direction and is configured to mate with the at least one indentation in the second holes. Each pin passes through different ones of the aligned holes.

### CROSS-REFERENCE TO RELATED APPLICATION

This patent application claims the benefit of U.S. Provisional Patent Application Ser. No. 62/380,840, entitled “Part Holder Utilizing Interlocking Pin and Plate Design,” filed Aug. 29, 2016, which application is incorporated in its entirety here by this reference.

### BACKGROUND

The use of custom fixtures to hold, clamp or support an object for some manufacturing processes such as machining, engraving, insertion, transporting or such is very common.

Many applications that require custom fixturing can also be addressed by using multiple pins that support, hold or clamp a part by conforming to the shape of the object. The pins are disposed in aligned holes in an assembly including a plurality of plates, and are usually biased by springs or the like. Each pin can move vertically through the aligned holes independently of one other and find their own height depending on the contact point. Once the pins meet the object the pins can be locked in that precise position. Prior art fixtures have used lateral displacement of an internal one of the plates to lock pins in place.

These fixtures, customized to the application, have the downside of being expensive, having a long build cycle, requiring ongoing maintenance and inventory management, storage costs, and end-of-life usefulness. For users of custom fixtures the desire to eliminate some or all of these disadvantages is very high and alternatives are in great demand

### BRIEF DESCRIPTION

According to one aspect of the present invention, a part holder (also referred to herein as a fixture) includes a plurality of helically threaded or laterally serrated pins disposed in holes in an assembly including a plurality of plates. The holes are clearance holes in that their diameters are larger in diameter than the crests of the threads or serrations of the pins.

At least one of the plates is a locking plate that includes holes, at least some of which include a locking feature that engages a locking feature of the pins when the locking plate is moved into a locked position. In one embodiment, the locking plate includes holes, at least some of which have at least one indentation formed therein in a radial direction. The pins each have a diameter less than a diameter of the holes in the plates. Each pin has at least one region extending outwardly therefrom in a radial direction and configured to mate with the at least one indentation in the holes. Alternately, the locking plate may include a single raised area that will nest between raised areas in the pin when the locking plate is moved into a locked position.

According to embodiments of the invention, at least one of the plates includes threaded or serrated holes in plate matching the pitch of the serrations or threads on the pins. Threaded pins and holes may provide advantages due to manufacturing advantages as well as allowing for adjustments when used in this application but a serrated pin and plate could also work.

The part holder is a matrix of threaded or serrated pins that are allowed to freely move through multiple plates in an unlocked position and are captured by the locking plate in a locked position.

According to one embodiment of the present invention, multiple plates have identical hole patterns. Holes in one or more of the plates will have a diameter selected for clearance of pins and will be threaded or serrated to match the thread or serration pitch of the pin threads. The holes in other plates will not be threaded so as to allow smooth movement of pins.

According to another embodiment of the present invention, three plates are provided with identical hole positioning and spacing in a pattern such as a matrix. The first and third plates are smooth bored and the middle plate is threaded or serrated. The middle plate is the “locking plate” whereas the first and third are “guide plates”. The middle plate is laterally movable between a “lock” position where the threaded or serrated hole engages the threads or serrations on the pin, and an “unlocked” position where the pin moves freely through the plates.

The diameter of the holes in all three plates is larger than the pin diameter to allow free movement. The middle plate hole diameter however is slightly larger than the guide plate holes. The reason for this is that when all three plates are lined up and in the “unlocked” position the pins need to be able to slide freely and without binding. Since the first and third plates are smooth bored that is not problem. But since the middle locking plate is threaded the crests of the threads should be slightly further back from the bored holes as to prevent any possibility of catching or binding the pins as the pins move through them.

### BRIEF DESCRIPTION OF THE DRAWING FIGURES

The invention will be explained in more detail in the following with reference to embodiments and to the drawing in which are shown:

FIG. 1 is a side view of a serrated pin in accordance with one aspect of the invention;

FIG. 2 is a top view of a clearance hole plate in accordance with one aspect of the invention;

FIG. 3 is a top view of a plate having threaded or serrated holes in accordance with one aspect of the invention;

FIG. 4 is a cross-sectional view of a serrated pin disposed in a plate assembly in an unlocked position according to one aspect of the invention;

FIG. 5 is a cross-sectional view of the serrated pin and plate assembly of FIG. 4 in a locked position according to one aspect of the invention;

FIG. 6 is a side view of a threaded pin in accordance with one aspect of the invention;

FIG. 7 is a cross-sectional view of a threaded pin disposed in a plate assembly in an unlocked position according to one aspect of the invention;

FIG. 8 is a cross-sectional view of the threaded pin and plate assembly of FIG. 7 in a locked position according to one aspect of the invention;

FIG. 9 is a top view of a matrix of pins in a plate assembly in accordance with one aspect of the invention;

FIG. 10 is a top view of a matrix of rotatable pins in a plate assembly in accordance with one aspect of the invention;

FIG. 11 is a cross-sectional view of a serrated pin disposed in a plate assembly in an unlocked position according to one aspect of the invention;

FIG. 12 is a cross-sectional view of the serrated pin and plate assembly of FIG. 11 in a locked position according to one aspect of the invention;

FIG. 13 is a cross-sectional view of a threaded pin disposed in a plate assembly in an unlocked position according to one aspect of the invention; and

FIG. 14 is a cross-sectional view of the threaded pin and plate assembly of FIG. 13 in a locked position according to one aspect of the invention.

### DETAILED DESCRIPTION

In the following description, numerous specific details are set forth in order to provide a more thorough description of the present invention. It will be apparent, however, to one skilled in the art, that the present invention may be practiced without these specific details. Other embodiments of the invention will readily suggest themselves to such skilled persons having the benefit of this disclosure. In some instances, well-known features have not been described in detail so as not to obscure the invention.

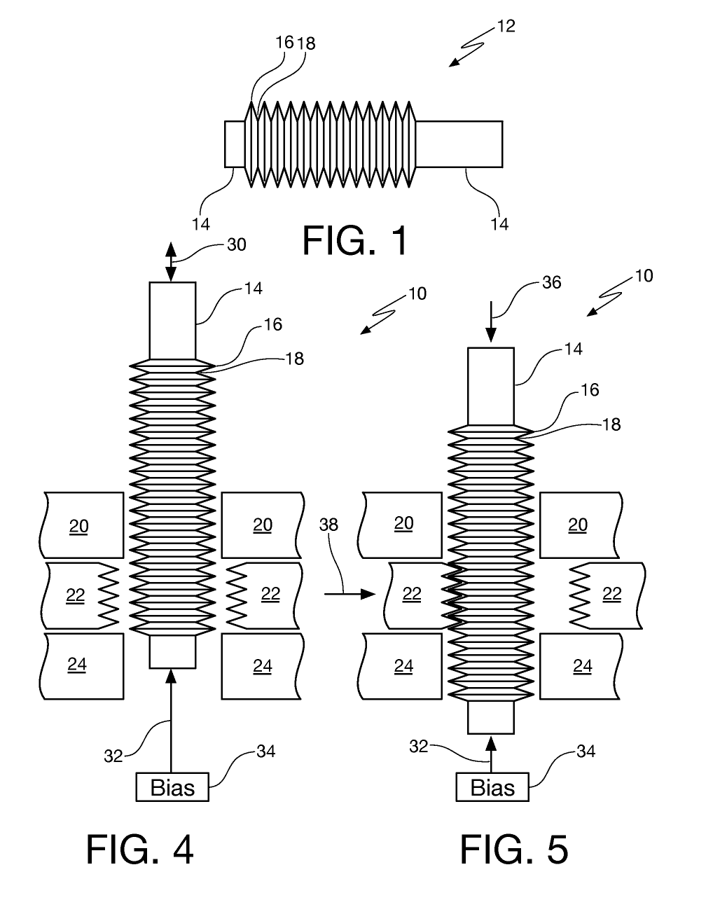

Referring to FIG. 1, in accordance with one aspect of the present invention, a fixture 10 includes a plurality of laterally serrated pins 12 (one of which is shown in FIG. 1) that include a shaft 14 having multiple serrations that preferably extend beyond the diameter of the shaft 14 including peaks (one of which is identified at reference numeral 16) and valleys (one of which is identified at reference numeral 18).

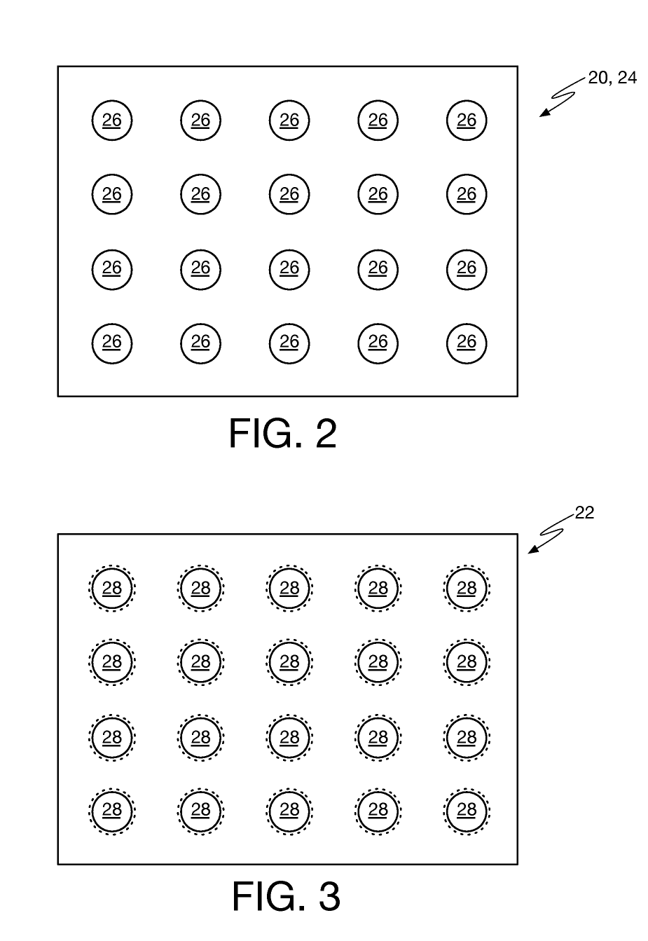

The fixture 10 also includes a plurality of plates 20, 22, and 24, shown in FIGS. 2 and 3. According to one embodiment, the multiple plates 20, 22, and 24 have identical hole patterns. Holes 26, as best seen in FIG. 2, are provided in one or more of the plates (shown as plates 20 and 24 in FIGS. 2, 4 and 5). The holes 26 are clearance holes in that their diameters are larger in diameter than the peaks 16 of the serrations of the pins 12.

Plates 20 and 24 shown in FIGS. 2, 4, and 5 each including a plurality of holes 26 spaced apart and aligned with one another. The holes 26 may be in a pattern, preferably but not necessarily in a matrix.

At least one of the plates (identified by reference numeral 22 in FIGS. 3, 4 and 5) is a locking plate and includes serrated holes 28 that align with holes 26 in plates 20 and 24. Holes 28 will also have a diameter selected for clearance of pins 12 but will have walls including serrations that match the serration pitch of the pins 12. In some embodiments all of the holes 28 include serrations and in other embodiments fewer than all of the holes 28 include serrations. Persons of ordinary skill in the art will appreciate that, while the embodiments disclosed herein employ two plates 20 and 24, embodiments of the invention employing one or more of plates 20 and 24 and plate 22 are contemplated to be within the scope of the present invention. Holes 28 may be circular having the same diameter as holes 26 or may be elongated or may have a diameter larger than the diameter of holes 26 in plates 20 and 24 to provide a longer distance of travel between an unlocked position and a locked position of the fixture 10 as will be discussed herein.

In some embodiments of the invention, the plates 20, 22, and 24 are arranged in contact with each other with a contact pressure selected to facilitate movement of the plate 22 relative to plates 20 and 24 between the unlocked position, as shown in FIG. 4, and the locked position, as shown in FIG. 5. In other embodiments of the invention, the plates 20, 22, and 24 may be mounted in a configuration where they are spaced apart from one another. As the fixture 10 of the present invention is scalable in size, the decision of whether the plates 20, 22 and 24 are arranged to be in contact with one another or spaced apart from one another will be a matter of design choice depending on the application. Such a choice is well within the level of ordinary skill in the art.

The fixture 10 may be viewed as a matrix or other arrangement of serrated pins 12 that are allowed to freely move up or down (as referenced in the drawing) through the holes 26 in the multiple plates 20 and 24, and holes 28 in plate 22 when it is in an unlocked position as indicated by arrow 30 in FIG. 4. When no object is present on the pins 12, they may be biased towards the top of the figure by a force indicated by arrow 32 applied by biasing mechanism 34. Biasing mechanism 34 may be in the form of, as non-limiting examples, a spring, a pneumatic or hydraulic ram or the like.

When an object is placed over the matrix of pins 12 it exerts a force (indicated by arrow 36 in FIG. 5) to drive the pins 12 through the holes 26, 28 in opposition to the biasing force 32. Regardless of the shape of the surface of the object in contact with the pins 12, each pin 12 will contact the surface of the object at a position along the axis of the pin 12. Embodiments of the invention are also contemplated wherein the pins 12 are biased in a downward direction and forced upward to meet an object placed in the fixture 10.

As shown in FIG. 5, the pins 12 may be captured by the locking plate 22 when the locking plate 22 is moved laterally as indicated by arrow 38 to a locked position in which the serrations on pin 12 mate with the serrations in holes 28 of plate 22. The fixture 10 may be mounted, for example, in a frame or by some other arrangement that holds the plates 20 and 24 in a fixed position with respect to one another so that their holes 26 are axially aligned. The frame restrains movement of plate 22 to a direction parallel to arrow 32. The locking plate 22 is shown in FIG. 5 being displaced to the right to move into its locked position but persons of ordinary skill in the art will appreciate that the locking plate 22 could also be displaced to the left to move into its locked position. The resolution of the position of each pin 12 along its axis in the locked position is defined by the pitch of the serrations of the pins 12 and the locking plate 22.

According to another aspect of the present invention, helically threaded pins 12 and holes 28 may provide advantages in manufacturing the locking plate 22 as well as advantages in use by allowing for adjustments when used in this application but a serrated pin and plate could also work.

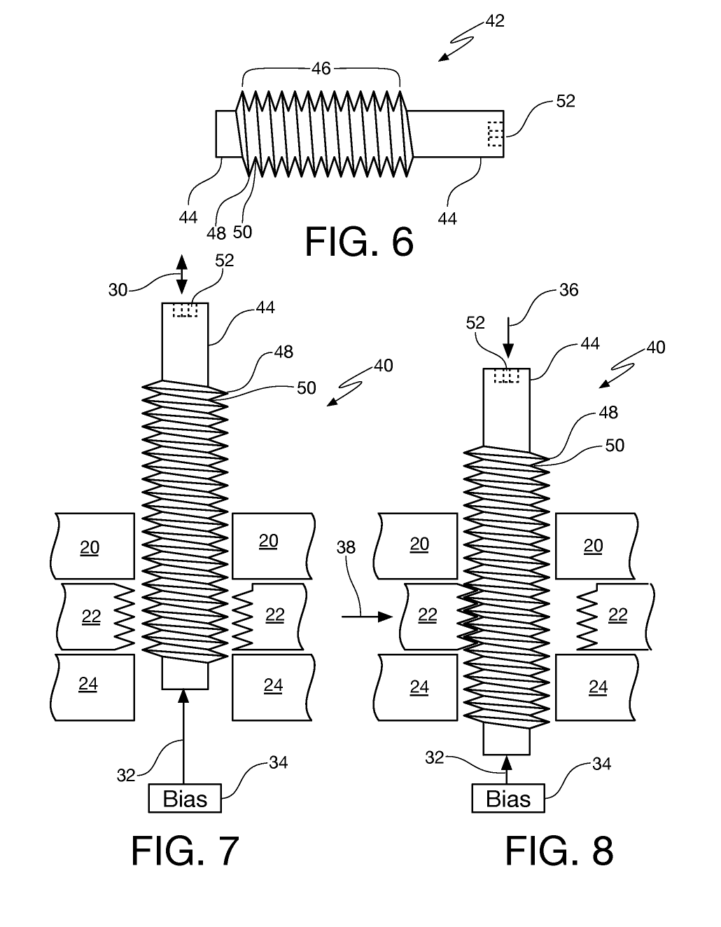

In accordance with another embodiment of the invention as illustrated in FIGS. 6, 7, and 8, a fixture 40 includes a plurality of pins 42 (one of which is shown in FIG. 6) that include a shaft 44 having a threaded portion 46, the threads including crests (one of which is identified at reference numeral 48) and roots (one of which is identified at reference numeral 50) as is known in the art. The crests 48 of the threaded portion 46 preferably extend beyond the outer circumference of the shaft 44.

The fixture 40 also includes a plurality of plates 20, 22, and 24, shown in FIGS. 2, 3, 7, and 8. According to one embodiment, the multiple plates 20, 22, and 24 have identical hole patterns. Holes 26 in one or more of the plates (shown as plates 20 and 24 in FIGS. 2, 7 and 8) will have a diameter selected for clearance of pins 42 and holes 28 in one or more other plates (22 in FIGS. 3, 7 and 8) will also have a diameter selected for clearance of pins 42 but will be threaded to match the thread pitch of the pins 42. The holes 26 in the other plates 20 and 24 will not be threaded so as to allow smooth movement of pins 42.

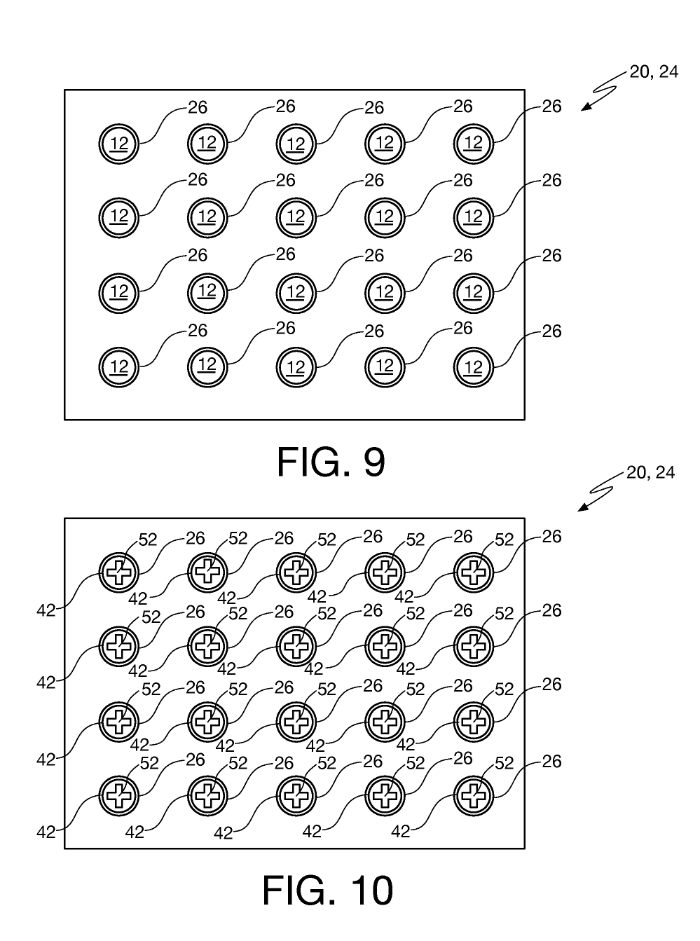

Plates 20 and 24 are shown in FIG. 9 each including a plurality of holes 26 spaced apart and aligned with one another, preferably but not necessarily in a matrix. The holes 26 are clearance holes in that their diameters are larger in diameter than the crests 48 of the threads of the pins 42. At least one of the plates (identified by reference numeral 22 in FIGS. 7 and 8) is a locking plate and includes threaded holes 28 that align with holes 26 in plates 20 and 24 and match the crests 48 of the threads on the pins 42. In some embodiments all of the holes 28 are threaded and in other embodiments fewer than all of the holes 28 are threaded.

In some embodiments of the invention, the plates 20, 22, and 24 are in contact with each other. In other embodiments of the invention, the plates 20, 22, and 24 may be mounted in a configuration where they are spaced apart from one another. As the fixture 40 of the present invention is scalable in size, the decision of whether the plates 20, 22, and 24 are arranged to be in contact with one another or spaced apart from one another will be a matter of design choice depending on the application. Such a choice is well within the level of ordinary skill in the art.

The fixture 40 may be viewed as a matrix or other arrangement of threaded pins 42 that are allowed to freely move up and down (as referenced in the drawing) through the holes 26 in the multiple plates 20 and 24, and the holes 28 in plate 22 when it is in an unlocked position as indicated by arrow 30 in FIG. 7. When no object is present on the pins 42, they may be biased towards the top of the figure by a force indicated by arrow 32 applied by biasing mechanism 34. Biasing mechanism 34 may be in the form of, as non-limiting examples, a spring, a pneumatic or hydraulic ram or the like.

When an object is placed over the matrix of pins 42 it exerts a force (indicated by arrow 36 in FIG. 8) to drive the pins 42 through the holes 26, 28 in opposition to the biasing force 32. Regardless of the shape of the surface of the object in contact with the pins 42, each pin 42 will contact the surface of the object at a position along the axis of the pin 42. Embodiments of the invention are also contemplated wherein the pins 42 are biased in a downward direction and forced upward to meet an object placed in the fixture.

As shown in FIG. 8, the pins 42 may be captured by the locking plate 22 when the locking plate 22 is moved laterally as indicated by arrow 38 to a locked position in which that the threads on pin 42 mate with the threads in holes 28 of plate 22. The locking plate 22 is shown in FIG. 8 being displaced to the right to move into its locked position but persons of ordinary skill in the art will appreciate that the locking plate 22 could also be displaced to the left to move into its locked position. The resolution of the position of each pin 42 along its axis in the locked position in fixture 40 is more finely controlled than the resolution of the position of each pin 12 in fixture 10 because the position of the pin 42 is not constrained like in the fixture 10 by the pitch of the serrations of the pins 12 and the locking plate 22. The threads of the pins 42 may be rotated in the mating threads of the holes 28 in plate 22 and the resolution of each pin is limited only by the angular resolution of rotation of the pin 42 combined with the crests 48 of the threads.

As shown in FIGS. 6, 7, 8, and 10 the ends of the pins 42 may include features to engage a rotation tool for rotating the pins 42. While a female phillips head pattern is shown formed in the end of pin 42 at reference numeral 52, persons of ordinary skill in the art will appreciate that any other means, such as but not limited to male or female slotted, torque head, hex head or other configurations, may be provided to rotate the pin 42. Each pin 42 may be coupled to a motor or other source of rotational force to automatically adjust its position. The source of rotational force may be individually coupled to each pin 42 or may be indexable under, for example CNC control, to make contact with individual pins 42. CNC control of such mechanisms is well known in the art.

According to one aspect of the present invention, the pins 12 or 42 may be formed from a strong material, preferably steel or another metal to insure longevity. In other applications, other materials such as synthetic materials and plastic material may be employed. The threads or serrations in both the pins 12, 42 and the center plate 22 will preferably have a peak 16 or crest 48 that is near theoretical sharp vs. rounded or flat, and the valley 18 or root 50 can be but is not necessary the same. The reason for shaping the pin 12, 42 and threaded or serrated plate peak or crest to be as close to theoretical sharp is that as the plate 22 moves into position to interlock with the pin 12, 42, the peaks 16/crests 48 must slip past each other and be allowed to move towards the thread valley 18/root 50. If the peak 16/crest 48 is not sharp enough the two peaks 16/crests 48 can potentially come in contact with and abut one another and prevent them from sliding past each other into the valley 18/root 50. This problem would be magnified when attempting to simultaneously “lock” a plurality of pins 12, 42. It would only take the threads or serrations of one pin 12, 42 abutting the threads or serrations of its hole 28 to prevent all pins 12, 42 from locking. In one embodiment, the locking plate 22 or pins 12, 42 may be vibrated to discourage abutting of threads or serrations. In other embodiments, the threads can be lubricated or a friction-reducing coating can be applied to them.

In some embodiments, the pitch of the threads or serrations of the plates 22 would be the same as the pins 12, 42. It is contemplated within the scope of the present invention that a different count of threads between the pin 12, 42 and hole 28 may be employed as long as the pitches are a multiple of one another.

As previously noted, the pins 12 and 42 may be biased by spring loading, fluid, foam, air, etc., or pin 42 may be motorized for rotation, which can be programmable.

The locking plates 22 can be moved into locked position by manual, motorized, or pneumatic means.

According to another aspect of the present invention, the fixture 10 or 40 may be set up using a coarse and fine adjustment. A basic setup employs a series of pins 12, 42 that are in an unlocked state, meaning they can independently move vertically (as referenced in the drawing) through the holes 26, 28 in the guide plates 20, 24 and locking plates 22. An object is placed on the pins 12, 42 and in doing so, depresses each pin 12, 42 by the amount defined by the contour of the object surface in contact with the pins 12, 42(or the pins 12, 42 are pushed up to contact the surface of the object). Once the object is in place and the pins 12, 42 have formed a contour of or around the object, the pins 12, 42 are locked by laterally moving the locking plate 22 into the locked position so as to mate and interlock the threads or serrations of the locking plate 22 with the threads or serrations of the pin 12, 42.

In an application where there are many pins 12, 42 contacting an object the vertical resolution of the position of each pin 12, 42 is dependent on the pin/plate thread pitch. The finer the pitch the greater the chance of contact with the object once the fixture 10, 40 is placed in its locked position. The chance of some pins 12, 42 not coming in contact increases with the coarseness of the pitch of the threads or serrations. In applications were the parts are very large and the tolerance for pin support location is high, the pin/plate pitch is less important. For smaller objects or those with very tight support needs the pitch becomes more critical. Further, because the threads or serrations of the pins 12, 42 and locking plate 22 each have a sharp peak 16/crest 48, the peak 16/crest 48 of each thread or serration pin 12, 42 has an uncertainty of plus or minus one groove in the valley 18/root 50 of the thread or serration in the locking plate 22. This uncertainty has the potential of creating a gap between the head of the pin 12, 42 and the object that could be unacceptable. If necessary this gap may have to be reduced or eliminated.

A solution to accommodate for this difference is to make it possible to perform a fine adjustment of the pin 12, 42 once it has been locked. If the fixture 40 is employed, each pin 42 can be rotated in either direction in order to move it vertically up or down (as referenced in the drawing) to a more precise location until it makes contact, through an opening in the pin fixture allowing access to the pin 12, 42 to rotate it.

Other embodiments of the present invention are contemplated. According to one such embodiment, different sized pin and hole combinations may be provided in the plates. Larger diameter pins will be able to carry a larger load from the object placed in the fixture.

In another embodiment of the invention, fewer than all of the holes in the second plates are provided with indentations and outer extensions such as serrations or threads and may be smooth bored. Pins placed in these holes may be biased with a larger force than pins captured by holes having the indentations.

According to another embodiment of the invention, more than one of the plates may have holes that include the indentations in the form of, for example, serrations or threads. In such an embodiment, the indentations in the holes in the multiple plates are positioned to match the spacing of the extensions on the pins, or the plates are spaced apart by a distance selected to match the spacing of the extensions on the pins.

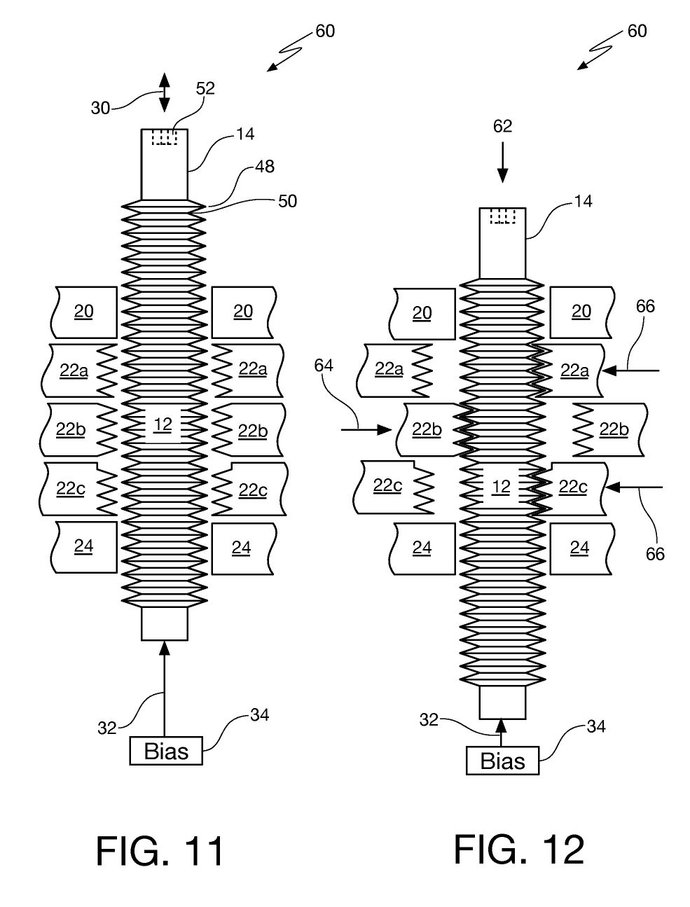

According to another aspect of the present invention, multiple locking plates can be employed. Referring now to FIGS. 11 and 12, an embodiment of the invention is shown wherein a fixture 60 employs serrated pins 12 that are captured between three locking plates 22a, 22b, and 22c. Locking plates 22a, 22b, and 22c are disposed between plates 20 and 24. FIG. 11 shows the fixture 60 in the unlocked position where pin 12 can freely move vertically between the stack of plates 20, 22a, 22b, 22c, and 24 as indicated by arrow 30. As in previously disclosed embodiments, pin 12 may be biased as shown by arrow 32 by a force exerted by biasing mechanism 34.

FIG. 12 shows the fixture 60 in the locked position where pin 12 has been depressed by the presence of an object (not shown) placed in fixture 60 as indicated by arrow 62. Locking plate 22b has been displaced to the right of the drawing figure until the serrations of pin 12 engage the mating serrations of the hole in locking plate 22b. Locking plates 22a and 22c have been displaced to the left of the drawing figure until the serrations of pin 12 engage the mating serrations of the holes in locking plates 22a and 22c. Persons of ordinary skill in the art will appreciate that embodiments of the present invention employing two locking plates are contemplated to fall within the scope of the present invention.

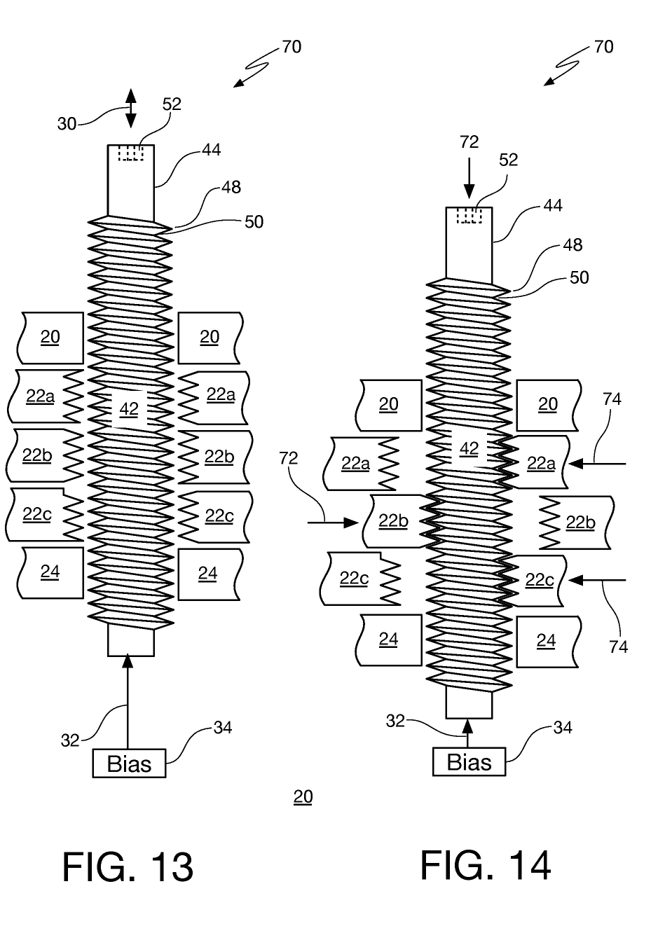

Referring now to FIGS. 13 and 14, another embodiment of the invention is shown using multiple locking plates wherein a fixture 70 employs threaded pins 42 that are captured between three locking plates 22a, 22b, and 22c. Locking plates 22a, 22b, and 22c are disposed between plates 20 and 24. FIG. 13 shows the fixture 70 in the unlocked position where pin 42 can freely move vertically between the stack of plates 20, 22a, 22b, 22c, and 24 as indicated by arrow 30. As in previously disclosed embodiments, pin 12 may be biased as shown by arrow 32 by a force exerted by biasing mechanism 34.

FIG. 14 shows the fixture 70 in the locked position where pin 42 has been depressed by the presence of an object (not shown) placed in fixture 70 as indicated by arrow 72. Locking plate 22b has been displaced to the right of the drawing figure as indicated by arrow 74 until the helical thread of pin 42 engage the mating helical thread of the hole in locking plate 22b. Locking plates 22a and 22c have been displaced to the left of the drawing figure as indicated by arrows 76 until the helical thread of pin 42 engage the mating helical threads of the holes in locking plates 22a and 22c. Persons of ordinary skill in the art will appreciate that embodiments of the present invention employing two locking plates are contemplated to fall within the scope of the present invention.

Persons of ordinary skill in the art will appreciate that the spacing of locking plates 22a, 22b, and 22c in the embodiments shown in FIGS. 11 through 14 will be selected to assure that the serrations or threads of the pins 12 and 42 will line up with the serrations or threads of the holes locking plates 22a, 22b, and 22c.

Persons of ordinary skill in the art will also appreciate that while the embodiments of FIGS. 11 through 14 show the direction of motion of locking plates 22a, 22b, and 22c being parallel to one another, the directions of motion could be otherwise, for example orthogonal. Each of locking plates 22a, 22b, and 22c could move in different directions.

In the embodiments shown in FIGS. 11 through 14, plates 20 and 24 help to stabilize the positions of the pins 12 and 42. Embodiments of the invention are also contemplated wherein plates 20 and 24 are omitted, and further that two locking plates may be employed in situations where lateral displacement of the pins 12 or 42 can be tolerated upon locking of the fixture.

While the fixtures 10 and 40 described and shown in the drawings is formed in a single plane, it is contemplated within the scope of the present invention to provide a fixture that can make contact with an object on one plane or in multiple planes. Pins can form a bed for which the object will sit on and is supported. Multiple pin and plate assemblies can be used to allow pins to engage the object from opposite sides or different orientations in order to hold the object in between them, or to allow pins to engage the object from the bottom and two sides like an open sided and top box.

There are numerous applications for the present invention, including but not limited to replacement of milling machine soft jaws, nest for holding parts, robotic grippers, high-pressure applications such as hydraulic presses, and replacement for other custom fixturing and tooling.

Although the above provides a full and complete disclosure of the preferred embodiments of the invention, various modifications, alternate constructions and equivalents will occur to those skilled in the art. Therefore, the above should not be construed as limiting the invention, which is defined by the claims.

What is claimed is:

1. A fixture comprising:
at least one first plate having a plurality of first holes formed therethrough;
at least one second plate having a plurality of second holes formed therethrough in alignment with the first holes in the first plate, at least some of the second holes in the second plate having at least one interlocking feature formed therein, the second plate aligned parallel to the first plate and moveable along an axis from an open position where the first and second holes are axially aligned to a locked position where the first and second holes are offset from one another; and
a plurality of pins, each pin having a diameter less than a diameter of the first and second holes, each pin having at least one interlocking feature configured to mate with the at least one interlocking feature of the second holes when the second plate is in the locked position, each pin passing through a different one of the first and second holes.

2. The fixture of claim 1, further comprising:
a mechanism coupled to each of the pins to bias the pins at a preselected position when no object is present in the fixture.

3. The fixture of claim 1, further comprising:
a mechanism couplable to each of the pins to rotate the pins to make contact at a preselected force with an object placed in the fixture when the fixture is in the locked position.

4. The fixture of claim 1 wherein the at least one first plate is in contact with the at least one second plate.

5. The fixture of claim 1 wherein the at least one first plate is spaced apart from the at least one second plate.

6. The fixture of claim 1, wherein:
the first holes and the second holes have substantially equal diameters; and
all of the pins have substantially the same diameters.

7. The fixture of claim 1, comprising a pair of first plates and a second plate disposed between the pair of first plates.

8. The fixture of claim 1 wherein the helical threads of the pins and the helical threads of the second holes are integral multiples of one another.

9. The fixture of claim 1 wherein the at least one indentation formed in the second holes of the second plate comprises serrations; and
the at least one region extending outwardly from the pins in a radial direction comprises serrations that mate with the serrations of the second holes.

10. The fixture of claim 1 wherein the at least one indentation formed in the second holes of the second plate comprises a helical thread, and
the at least one region extending outwardly from the pins in a radial direction comprises helical threads that mate with the helical threads of the second holes.

11. A fixture comprising:
at least one first plate having a plurality of first holes formed therethrough;
at least one second plate having a plurality of second holes formed therethrough in alignment with the first holes in the first plate, at least some of the second holes in the second plate having helical threads formed therein, the second plate aligned parallel to the first plate and moveable along an axis from an open position where the first and second holes are axially aligned to a locked position where the first and second holes are offset from one another; and
a plurality of pins, each pin having diameter less than a diameter of the first and second holes, each pin having a helical thread mating with the helical threads in the second holes, each pin passing through a different one of the first and second holes.

12. The fixture of claim 11, further comprising:
a mechanism coupled to each of the pins to bias the pins at a preselected position when no object is present in the fixture.

13. The fixture of claim 11, further comprising:
a mechanism couplable to each of the pins to rotate the pins to make contact at a preselected force with an object placed in the fixture when the fixture is in the locked position.

14. The fixture of claim 11 wherein the at least one first plate is in contact with the at least one second plate.

15. The fixture of claim 11 wherein the at least one first plate is spaced apart from the at least one second plate.

16. The fixture of claim 11, wherein the first holes and the second holes have substantially equal diameters.

17. The fixture of claim 11, comprising a pair of first plates and the second plate is disposed between the pair of first plates.

18. The fixture of claim 11 wherein the helical threads of the pins and the helical threads of the second holes are integral multiples of one another.

19. A fixture comprising:
at least one first plate having a plurality of first holes formed therethrough;
at least one second plate having a plurality of second holes formed therethrough in alignment with the first holes in the first plate, at least some of the second holes in the second plate having spaced apart annular serrations formed therein, the second plate aligned parallel to the first plate and moveable along an axis from an open position where the first and second holes are axially aligned to a locked position where the first and second holes are offset from one another; and
a plurality of pins, each pin having diameter less than a diameter of the first and second holes, each pin having annular serrations mating with the annular serrations in the second holes, each pin passing through a different one of the first and second holes.

20. The fixture of claim 19, further comprising:
a mechanism coupled to each of the pins to bias the pins at a preselected position when no object is present in the fixture.

21. The fixture of claim 19 wherein the at least one first plate is in contact with the at least one second plate.

22. The fixture of claim 19, wherein the at least one first plate is spaced apart from the at least one second plate.

23. The fixture of claim 19, wherein the first holes and the second holes have substantially equal diameters.

24. The fixture of claim 19, comprising a pair of first plates and the second plate is disposed between the pair of first plates.
